(19) United States
(12) Patent Application Publication
(10) Pub. No.: US 2014/0108296 A1
(43) Pub. Date: Apr. 17, 2014

(54) Future Cost of Retirement Index and Fund

(71) Applicant: BlackRock Index Services, LLC, New York, NY (US)

(72) Inventors: Matthew Arnold O'Hara, San Francisco, CA (US); Charles A. Castille, III, San Francisco, CA (US)

(73) Assignee: BlackRock Index Services, LLC, New York, NY (US)

(21) Appl. No.: 14/053,036

(22) Filed: Oct. 14, 2013

Related U.S. Application Data
(60) Provisional application No. 61/837,762, filed on Jun. 21, 2013.
(60) Provisional application No. 61/713,589, filed on Oct. 14, 2012.

(51) Int. Cl. G06Q 40/06; G06Q 40/08

(52) U.S. Cl. CPC G06Q 40/06; G06Q 40/08
USPC 705/36 R; 705/4

(57) ABSTRACT

A future cost of retirement index is used to quantify the present value of future income. The future cost of retirement index provides a way for an investor to quantify the present cost of funding a secure future income for retirement. Upon establishing a cost of retirement index that quantifies a present value of future estimated investment returns, an investment funds track the index. This permits an investor to accumulate funds that approximate an amount needed to purchase, at a future time, a defined income stream for life. Because the future cost of retirement index fund is not itself an annuity, but is merely a tool that can be used to acquire sufficient assets to purchase an annuity, a future cost of retirement index fund facilitates retirement planning while also preserving asset liquidity.

### CROSS REFERENCE TO RELATED APPLICATIONS

This application claims the benefit of U.S. Provisional Application No. 61/713,589, filed Oct. 14, 2012, and U.S. Provisional Application No. 61/837,762, filed on Jun. 21, 2013, which are incorporated by reference in their entireties.

### BACKGROUND

The present disclosure relates generally to financial services and financial products, and more particularly to the development of an index based on a future cost of a defined income stream and financial products (such as collective trust funds, mutual funds, exchange-traded funds, and separately managed accounts) that are based on that index.

As people live longer, the responsibility for retirement planning is shifting to individuals as underfunded defined benefit programs are replaced with defined contribution plans and IRAs. Many prospective retirees are unprepared for the complexity of planning and funding a retirement that meets their objectives. In addition to this lack of preparation, people nearing retirement face the “retirement problem”—that is, the problem of how to consume wealth efficiently in light of an uncertain lifespan, and uncertain investment returns. Three fundamental challenges contribute to this “retirement problem”: investment risk, mortality risk, and ingrained behavioral issues. These challenges can cause problems for retirees on an individual basis and can also contribute to a broader problem as the Baby Boom generation nears retirement, as 70 million Americans will retire in the next 20 years.

Effective retirement planning requires managing uncertain returns and an uncertain lifespan even though these two factors are essentially unrelated. Additionally, the “retirement problem” can be compounded by economic conditions in which low yields and volatile returns are common. This is further complicated by uncertain life spans that can cause individuals to outlive their financial resources.

In addition to the above factors, well-known and ingrained behavioral traps, when applicable, must be overcome to achieve desired retirement outcomes. These traps include a tendency to confuse investment risks and mortality risks, mismanage retirement consumption, and misunderstand the benefits of longevity insurance.

In some cases, investors manage investment risk, mortality risk, and behavioral traps by using investment vehicles providing a guaranteed lifetime income, such as annuities. While annuities, usually provided by insurance companies, are the most common form of guaranteed lifetime income, there are obstacles to their widespread acceptance. One obstacle is behavioral. Individuals do not easily accept the benefit of an annuity. For example, individuals perceive a negative financial situation if they die prematurely because the annuity investment is lost to the individual's heirs. Often unconsidered to temper this view is that a longer lifetime, usually perceived as a benefit, may involve the individual outliving his financial resources, leading to destitution in old age.

Another obstacle is the opacity of the annuity market itself. Most individuals do not understand how annuities are priced and they do not regularly see annuity pricing information. Yet another obstacle is the loss of liquidity and control over financial resources that comes from buying an annuity.

### SUMMARY

A future cost of retirement index is described that can be used to quantify the present value of future income. In one embodiment, the index tracks an expected amount of present value that would be needed to purchase, upon a future target date, a fixed amount of income for life (e.g., a $1 per month annuity payment). One advantage of a future cost of retirement index is that it is more transparent to investors because it provides a way for an investor to quantify the present cost of funding a secure future income for retirement.

Upon establishing an index that quantifies this present value, one or more funds may be created to track the index (individually, a “Fund,” collectively “Funds”). Embodiments of these Funds permit an investor to accumulate funds that approximate an amount needed to purchase, at a future time, a defined income stream for life. Because the Fund is not itself an annuity, but is merely a tool that can be used to acquire sufficient assets to purchase an annuity, these Funds facilitate retirement planning, while also preserving asset liquidity, enabling an investor to access the funds prior to actually purchasing an annuity.

### BRIEF DESCRIPTION OF THE DRAWINGS

FIG. 1 is a graph illustrating a range of present values of one dollar of income as a function of investor age on the annuity purchase date, in an embodiment.

FIG. 2A is a graph illustrating mortality rate as a function of age and presented in terms of a conditional survival probability, in an embodiment.

FIG. 2B is a graph illustrating mortality rate as a function of age and presented in terms of a mortality projection factor, in an embodiment

FIG. 3 is a graph of a discount curve for translating a future cash flow into a present value as a function of time, in an embodiment.

FIG. 4 is a flow diagram of a method for selecting investments to include in a future cost of retirement index fund, in an embodiment.

FIG. 5 is a flow diagram of a method for redeeming shares of a future cost of retirement index fund, in an embodiment.

The figures depict various embodiments of the present disclosure for purposes of illustration only. One skilled in the art will readily recognize from the following discussion that alternative embodiments of the structures and methods illustrated herein may be employed without departing from the principles described herein.

### DETAILED DESCRIPTION

OVERVIEW

In embodiments of the present disclosure, a future cost of retirement index is described that can be used to quantify the present value of future income. In one embodiment, the index tracks an expected amount of present value that would be needed to purchase, upon a future target date, a fixed amount of income for life (e.g., a $1 per month annuity payment). One advantage of a future cost of retirement index is that it is more transparent to investors because it provides a way for an investor to quantify the present cost of funding a secure future income for retirement.

Upon establishing an index that quantifies this present value, one or more funds may be created to track the future cost of retirement index (individually, a “Fund,” collectively “Funds”). Embodiments of these Funds permit an investor to accumulate funds that approximate an amount needed to purchase, at a future time, a defined income stream for life. Because the Fund is not itself an annuity, but is merely a tool that can be used to acquire sufficient assets to purchase an annuity, these Funds facilitate retirement planning, while also preserving asset liquidity, enabling an investor to access the funds prior to actually purchasing an annuity.

### FUTURE COST OF RETIREMENT INDEX EXAMPLES

Examples of future cost of retirement indices include those that are indexed to different investor time horizons. A first index may be determined using an approximate or anticipated retirement age (e.g., 62, 65, 67, 72, etc.) as a starting point for an income stream. A second embodiment of an index can be determined using a designated advanced age (e.g., 80, 85, 90, etc.) of the purchaser for the starting point of the income stream. This latter index is useful to measure the present cost of an income for a longer than expected lifespan. The age selected, whether mentioned above or some other age, is then used as one factor to calculate the future cost of a retirement income and a future cost of income over an extended lifespan.

As discussed below, an index can be used as a benchmark for a Fund that holds a portfolio of investments (whether stocks, bonds, derivatives, or other investments) that can be used by investors to accumulate assets needed to fund retirement.

### DETERMINING A FUTURE COST OF RETIREMENT INDEX LEVEL

A conventional investment index typically selects a group of securities or other investments (stocks, real estate, bonds, derivatives, etc.) to be used as a benchmark, and then sets the index level in proportion to the value of the selected securities or other investments. Unlike this conventional system, embodiments of the present invention determine an index level first and then determine the securities or other investments to achieve the index level. The index level of the index is set as the present value needed to provide $1 (or other amount) of periodic income for life starting in the future. The periodic income of $1 is used for convenience and can be any amount or even be adjusted for cost of living increases. Similarly, while many of the following examples describe the periodic income being monthly, other time periods may be used. The periodic income is often secured through the purchase of an annuity. The annuity income begins at a selected age of an investor (e.g., an anticipated retirement age or an age indicating an unexpectedly long lifespan) and ends at the investor's end of life.

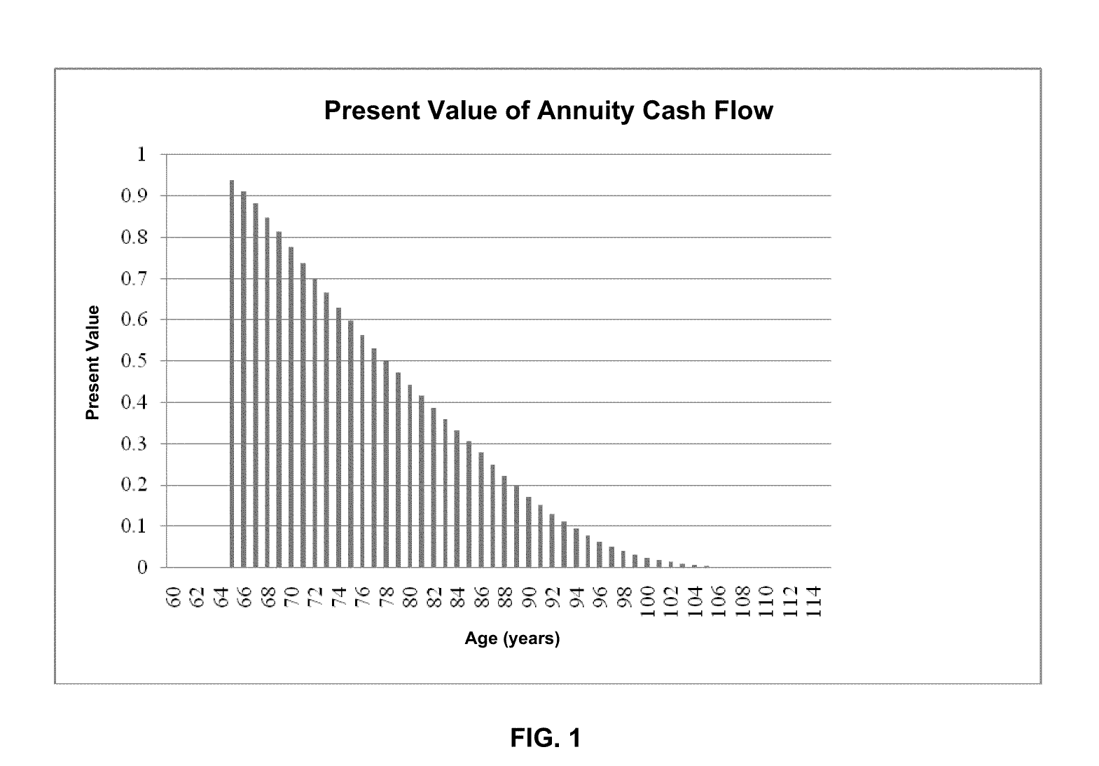

FIG. 1 illustrates a range of present values as a function of investor age on the annuity purchase date. The present value also includes factors incorporating estimated finance charges used to purchase an annuity, such as annuity provider profit margin and mortality mis-estimation factors.

The first step of setting the index level includes determining a return (e.g., in the form of a series of periodic cash flows) from one or more bonds (or other securities) over an investment period that, at upon redemption, is sufficient to purchase an annuity in the future that will provide $1 of monthly income for life. This investment period begins on an “investment date” on which the investor purchases Fund shares and ends on a “redemption date” on which the investor redeems the Fund shares and uses the proceeds to purchase, for example, an annuity. Because the monthly income is for life, the investment return needed (and therefore the annuity price) is determined, in part, by societal expectations for mortality—that is, the length of time over which the income stream is paid to a group of annuitants. To provide mortality-pooled investments to individuals, insurance companies must estimate the average distribution of mortality then make allowances for sampling error, adverse selection and other potential causes of mis-estimation. The future cash flow is estimated by using mortality estimates for the general population.

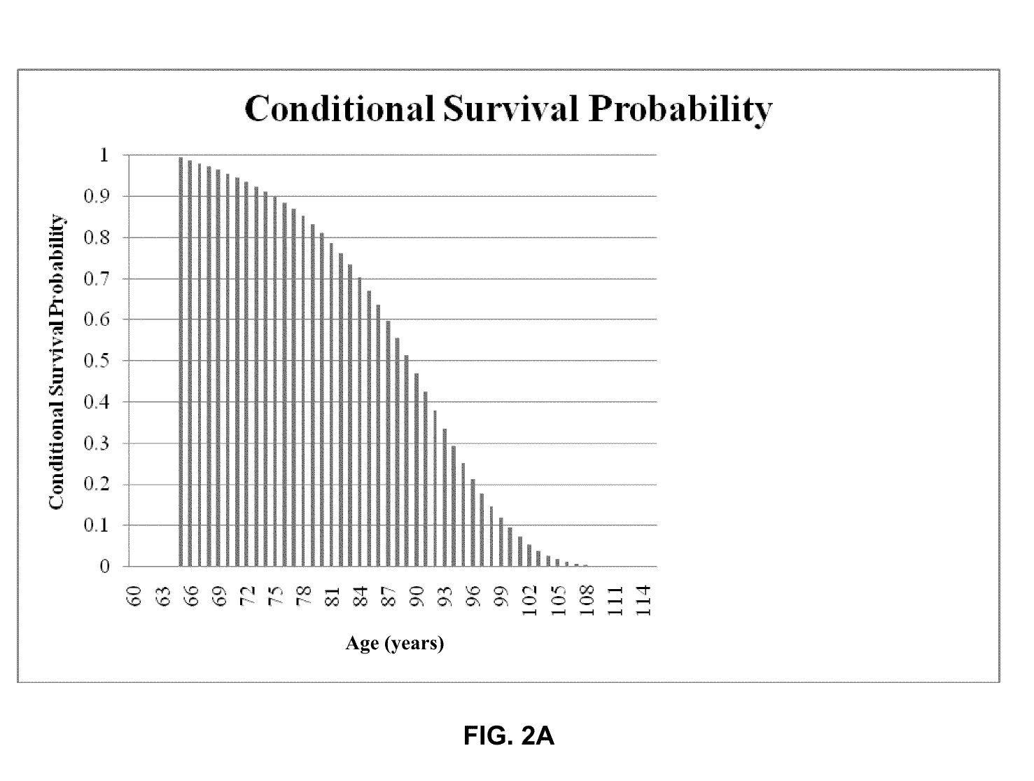

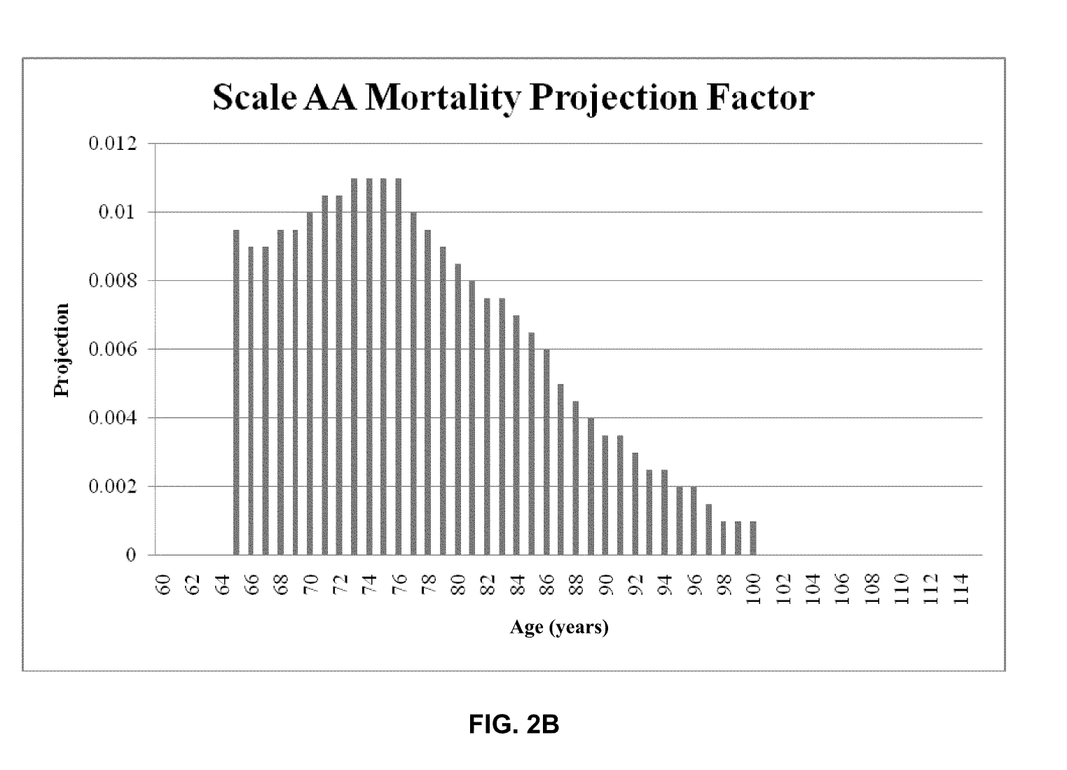

Population mortality assumptions can be determined using any of a number of mortality distribution data sources. For example, the Society of Actuaries RP-2000 Table D is a mortality table that assumes a population having an equal percentage of men and women (important because of differing mortality rates between the genders) that can be used to anticipate mortality rates in the population in a given year, or a mortality rate of a sub-population of a given age. Similar tables prepared by the National Center for Health Statistics, the Social Security Administration, private sources, and state actuary offices may also be used. Similarly, mortality tables (alternatively known as “life expectancy tables”) can be selected for use based on the assumptions they make, such as the improvement in lifespan through time, male to female population ratio changes as a function of age cohort, and other population characteristics. These mortality tables or life expectancy projections can be determined based on data from any type of population (e.g., global, national, regional, geographic, age, race, other demographic features, or combinations thereof). In some examples, mortality tables are based on data from the general population, any or some of the sub-populations described above, and/or on the population of people purchasing annuities. Examples of these mortality data appear in FIGS. 2A and 2B.

In addition, to appropriately price an annuity (and in this example, the future cost of retirement), insurance companies must estimate the average distribution of mortality and make allowances for sampling error, adverse selection and other potential causes of mis-estimation.

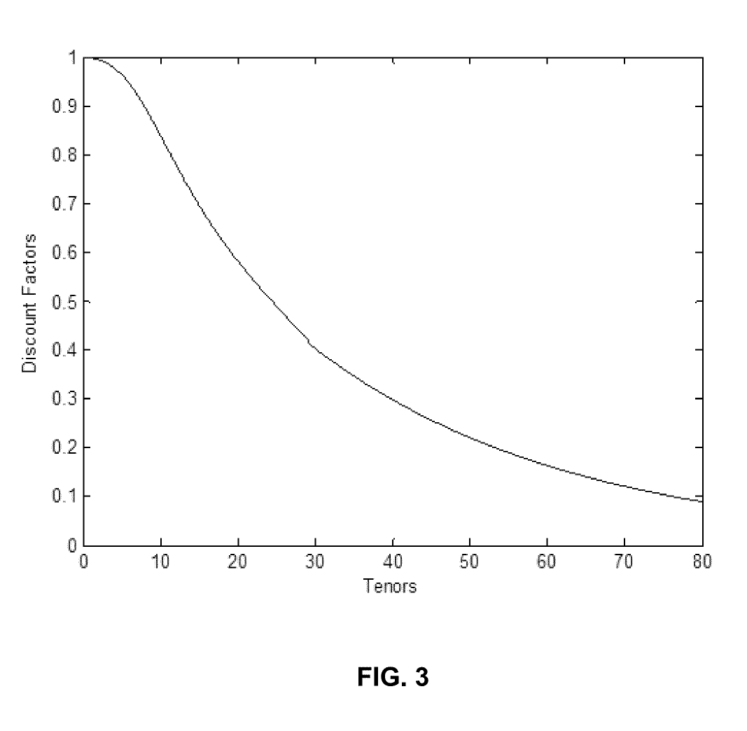

Next, having determined the future investment returns from the securities between the investment date and the redemption date, a present value of these returns is calculated using a discount function (also known as a “discount curve”) on the cash flows. The goal of the discount function is to reliably translate a series of future cashflows (which in some cases are periodic, or modeled as such) into a present value, accurately, as a function of time. An example discount curve appears in FIG. 3.

The discount function is based on (and in some cases, proportional to) a yield curve (that is, a curve of investment return through time for a given term) for one or more annuity providers and also a function of an estimated profitability measure expected by an annuity provider for selling the annuity and investing the proceeds. In some examples, this estimated profitability is characterized as a “pricing premium” charged by the annuity provider. The yield curve used to calculate the discount function can be determined using one or more annuity providers in any type of combination.

Yield curves (or alternatively credit curves), which identify an interest rate of a security as a function of time, are used to calculate the discount function by translating a targeted future cash flow into present dollars. In other words, the periodic (annual, monthly, daily, etc.) cash flow of a given security having a known interest rate as a function of time is converted to a present value using the equation D(t)=1/(1+yₜ)^{t}, where “y” is interest rate, “t” is time, and “D” is the factor used to convert future periodic cash flows from a security into present dollar terms.

In some embodiments, the discount rate is further adjusted by a risk charge that reflects insurance fees charged for unexpected shifts in mortality (or other changes) and/or interest rate risk. For example, advances in medicine or medical technology, nutrition, and/or lifestyle can, over time, affect the mortality rates of populations, thereby increasing the amount paid by an annuity provider to annuity owners during the prolonged life spans. Similarly, changes in interest rate due to unexpected or volatile economic conditions can adversely affect the profitability or financial solvency of an annuity provider. This risk charge is applied to account for these variations. In some cases, the risk charge is determined empirically by polling annuity providers. In other examples, the risk charge is determined directly using economic and statistical inputs (mortality change rates, inflation rate projections, etc.) to a risk charge model.

The accuracy of the discount function, and the yield curves used to calculate the discount function, is important because the discount function is used to calculate the present cost of a future annuity, whereas only current annuity prices are known. Even small errors in the discount function applied to current annuity prices can lead to substantial errors when used to determine annuity prices that are five, ten, or twenty years in the future.

A discount function that is used to calculate the cost of an annuity in the future, and therefore the index level , can anticipate or model, in part, fluctuations in credit markets. This enables the index level to approximate or track the future price of a lifetime income stream. In one embodiment, a discount function that accurately discounts future income flows to current dollars (or alternatively, estimates the present cost of a future income stream) is established using the U.S. Treasury curve +0.5 (BBB-rated corporate bond yield curve—AA-rated corporate bond yield curve) —(a fixed spread). In another example, a discount function can be calculated using the U.S. Treasury curve +0.5 (B-rated corporate bond yield curve—A-rated corporate bond yield curve)—(a fixed spread). The discount function may also be modeled using additional or other securities, including types of bonds, equity indexes, derivatives, other securities or security indexes, or yield or credit curve combinations.

The “fixed spread” term of the preceding may be determined by considering a number of factors. In one example, the fixed spread accounts for a profit for the annuity provider, adverse selection (i.e., the tendency of the mortality of the population who invests in annuities to deviate from the general population, in a way that is favorable to the annuity purchaser), and a generalized error. The generalized error accounts for non-specific or non-attributable error in the discount function. For example, the generalized error term can be used to empirically fit the discount function to better match historical data, thereby improving the accuracy of the discount function as applied to projecting future cash flows. In another example, the generalized error term can be used to correct for statistical error, such as variation caused by the standard deviation in a data set, or other measurements of statistical error.

In some embodiments, an index (as well as an associated Fund) can have a maturity date, after which the index will no longer track the future cost of future retirement income (i.e., the income tracked before age 65 of an investor) but instead track the current cost of purchasing lifetime income (i.e., retirement income that is the investor income at and after age 65 up to an expected mortality date). Tracking the current cost of purchasing lifetime income is accomplished using a similar process to that described above, with some variations.

In one variation, aspects of the mortality assumptions are changed to calculate a more cost effective cash flow. Conditional life expectancy increases as an investor ages (i.e., the life expectancy of a 70 year old person is greater than that of a 65 year old person), however, the annuity cash flows from ages 65 to 70 previously included in the cost of the annuity can be removed from the cost calculation. The net of these two competing effects makes the annuity less expensive over time.

In another variation, an index can include a cost of living adjustment in each year after retirement. Because this adjustment is applied in every year when calculating the cost of converting future retirement income to lifetime income, all else being equal, this makes the annuity more expensive over time. The adjustment can be a fixed percentage or can track a consumer price index or other similar index.

In yet another variation, both of the two immediately preceding variations can be combined. The net effect can be an overall decrease in the cost of the annuity, although different interest rate environments can actually increase the cost. In the event of a decrease of cost and/or in the event that the performance of a Fund's investments exceed the costs of the Fund, the difference can be paid to investors as income or re-invested in the Fund to increase the amount of achievable income for annuity investors (similar to the effects observed in Social Security).

These equations are used to discount future cash flows, or otherwise model the future cost of an annuity, and do not necessarily reflect the actual securities or other investments used.

The foregoing process is used to model the desired performance as a function of time. Having established the performance model, an optimized bond (or other investment) portfolio is identified that will approximately track the performance model and will be published as an index, which may comprise a plurality of constituent assets (e.g., bonds) and their corresponding weights in the index.

To select the bonds and their respective weights for the index, a universe of bonds is first identified and their corresponding characteristics are received or identified. Characteristics of bonds relevant to selection include the bond issuer, interest rate, the currency in which the bonds are denominated, economic sector (sovereign, municipal, corporate, etc.), whether the bonds are illiquid, whether the bonds are securitized, the bond rating (as issued by a rating agency such as Moody's, S&P, and Fitch), as well as cash flow and yield curve-derived characteristics such as duration, key rate durations, duration times spread, spread duration, and other similar characteristics. These characteristics can be identified or received using a computing device or client operating on a computing device that is in communication with, for example, an investment database, an investment rating agency, or other source of investment characteristics.

The selection criteria used to narrow the universe of bonds to a list of eligible bonds are then defined. The selection criteria may be defined by an index administrator and may encompass measurements of risk tolerance (such as the risk of default or risk of inflation of a particular currency), liquidity, rating, and other criteria that are not necessarily listed above. The selection criteria may be a function of the professional judgment and personal discretion of an index administrator given the diversity of selection criteria combinations possible, as well as the role of experience and insight of an individual.

Once defined, the selection criteria may be applied to the universe of bonds thereby determining a set of bonds eligible for use in the portfolio. In the event that more bonds are eligible than are intended or needed for inclusion in the portfolio, an administrator may again apply professional judgment and personal discretion to further select bonds.

The bonds selected for the index are then optimized by determining the weight of each selected bond. The goal of optimizing the selected bonds in this way is so that the index then matches the desired performance as a function of time as described above using the yield curve and discount function model. Some combination of the parameters listed above are matched in various proportions in support of this optimization. Although the final weights are at the discretion of an administrator, the optimization described here guides the selection. Furthermore, the final weighting of bonds is chosen such that the relative proportion between bonds in the marketplace is largely maintained. This improves the investability of the resulting index.

Upon determining the constituents of the index and their respective weights, the resulting index can be used as a benchmark for one or more Funds, described below.

While the above description is one example of a method for determining an index, this method is only one example. Indeed, the method used to determine an index is ultimately up to the judgment and discretion of an administrator given that the methods used to construct an index, calculate yield curves, determine discount functions, and other aspects of the above-described method are varied.

### DETERMINING SECURITIES OR OTHER INVESTMENTS FOR INCLUSION IN A FUND

Having established an index level using the yield curve and discount function described above, a portfolio of securities or other investments (e.g., bonds, stocks, derivatives) is then selected that will have the same or similar fixed income characteristics, and thus achieve a Fund return that approximates the return of the index. This step is useful because in some cases the constituent bonds (or other investments) in the index, and/or their respective weights, may not be readily or conveniently available to an investor. As such, a Fund that approximately matches the desired performance and/or characteristics of the index and is accessible to an investor is created.

As described above, the index level is set by the present value of the future $1 of monthly income and tracks the changes in price associated with purchasing lifetime income at some point in the future. This index level is used as part of a process for identifying a portfolio of securities or other investments for the Fund that enables investors to have sufficient funds in the future to purchase an annuity. Three example methods for determining the portfolio of securities or other investments to be held by the Fund are discussed below.

A first example method for determining the portfolio of securities or other investments to be held by the Fund is to calculate the duration (using the mortality tables described above), the yield, and key rate durations of the expected annuity cash flows. Once these are determined, a portfolio of bonds, stocks, derivatives, or other investments that most closely matches the duration, yield, and key rate durations of the modeled annuity is then identified. Key rate duration refers to the sensitivity of a price of a security (or value of a portfolio) to changes in yield of the security (or yield of a portfolio) for a given maturity.

A second example method for determining the group of securities or other investments to be held by the Fund is to calculate a duration times the spread (“DTS”) of groups of annuity cash flows from different time periods in the future (e.g., a 5 to 7 year time period, a 7 to 10 year time period). These values are then matched with equivalent values from a selection of bonds from a set of candidate bonds.

A third example method for determining the group of securities or other investments to be held by the Fund is to match the cash flow from an annuity, calculated above, as closely as possible to the cash flows from universe selection of candidate securities or other investments. Identifying candidate securities or other investments is described in more detail below.

In this example investment selection method, a universe of investments available for selection can start with a broad scope. For example, the universe can initially include candidates of sovereign bonds, U.S. Treasury securities, stocks, derivatives, and other liquid credits. In some examples, the candidates in the universe can then be narrowed by screening the candidate investments for an acceptable degree of liquidity, using e.g., a model used for fixed-income security analysis. In other examples, the candidates can be narrowed using other criteria, including the nature of the investment, e.g., whether the investment is a municipal bond, whether it includes mortgage debt, and other factors. In other examples, the maturity and liquidity are used to select or narrow a candidate group of bonds. For example bonds having a maturity of two years or more are used as an initial candidate group of investments. This candidate group can be further limited by including only those bonds that are investment grade, and/or do not include option contracts, mortgages, or are otherwise securitized bonds.

The candidates are then evaluated after this screen based on their economic characteristics or industry sector in order to preserve the desired diversity of the Fund's portfolio. Diversity factors can include the financial size of the business providing a corporate bond (annual revenues or annual profit), the investment characterization of the business (growth, value, mid-capitalization, etc.), the economic sector (health care, manufacturing, minerals and mining, etc.), and other factors.

In some examples, only U.S. dollar-denominated securities are considered. In other examples, only sovereign bonds are considered. In this latter case, only those sovereign bonds having less than a certain level of a risk of default are considered. Other similar screens, and combinations thereof, can be used to limit the investments considered for a portfolio.

In some applications of the above methods and screens, the portfolio of selected investments may be concentrated in a limited number of market areas (geographic regions, bond types, bond maturities, risk levels, etc.). Because the Fund is intended to be an index fund that should track the performance of an index, concentration of investments in particular market areas can counter the intended performance of the Fund. To reduce the concentration, one method of screening investments includes first screening the eligible investments for liquidity and then using the DTS value discussed above to match one or more investments to the targeted cash flows calculated using mortality data, and other factors, as described above. This method is analogous to techniques used in “liability driven investing.”

Applying these techniques models the cost of supplying an annuity (including the financial performance of the annuity provider) in the future. This future cost is then used to estimate the cost of purchasing the annuity in the future for a determined monthly income stream. By modeling cash flows of investments, the present value needed to purchase investments that match this future cost can be calculated, thereby assisting prospective retirees plan for an adequately funded retirement.

As with the process for selecting bonds and other investments for an index, parts of the selection method for a Fund may be performed by a computing device. For example, the quantifiable characteristics of the universe of investments (economic sector, interest rate, rating, etc.) may be received from a source of such information (e.g., a ratings agency) and initially screened using a computing device. However, the ultimate selection of bonds and other investments for the Fund portfolio may be up to the discretion and judgment of a Fund portfolio manager. For example, while the goal of a Fund is to track the performance of an index, a Fund portfolio manager may determine, in her professional judgment, to use different bonds or other investments in the Fund compared to the index, weigh them differently, make decisions about risk level, investment diversity, or other decisions that cannot be calculated or quantified by a computing device.

### APPLICATIONS

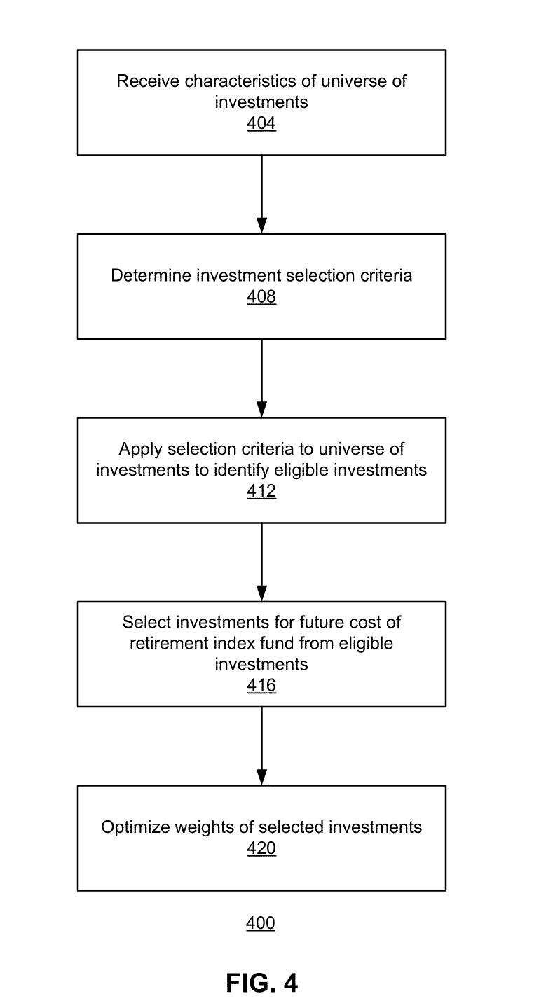

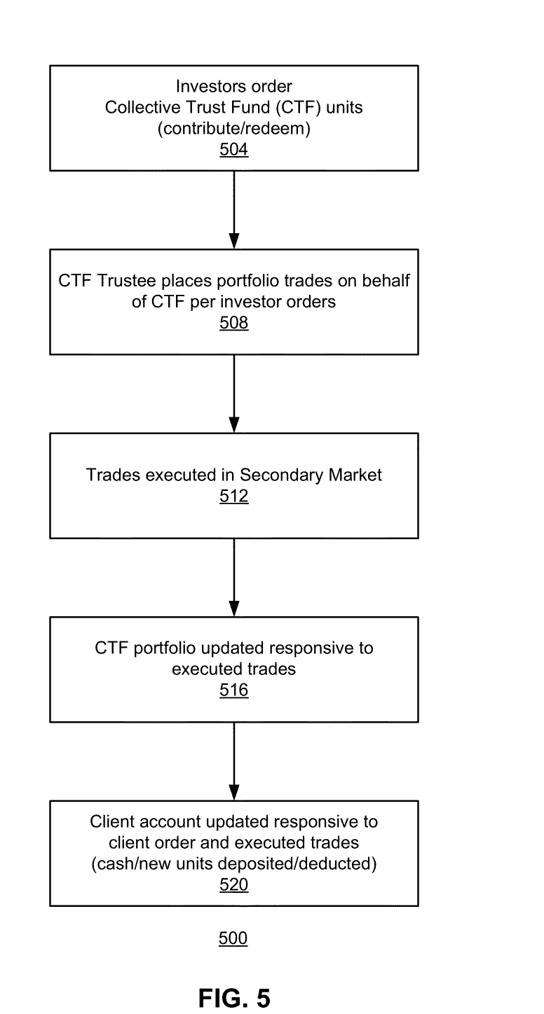

The shares of a Fund may be made available to investors through any appropriate investment product. FIGS. 4 and 5 illustrate a simplified contribution and withdrawal process for a Fund in accordance with one embodiment. In this case, the Fund described is a collective trust fund (“CTF”) although a Fund could be another type of fund or account. While a CTF is used for convenience in the following illustration, other investment vehicles, such as mutual funds, exchange traded funds, and separately-managed accounts, among others, can also be used.

Investors place contribution or redemption orders with a CTF Trustee. For example, an investor can contribute to the CTF by contributing funds used for the purchase of CTF units. In another example, an investor can instruct the CTF Trustee to redeem units of the CTF, thereby exchanging the units for funds in an amount equal to the value of the units, which are ultimately distributed to the investor.

In either case, the CTF Trustee executes CTF portfolio trades in the markets for the portfolio securities or other investments (referred to in FIG. 5 as the “Secondary Market”). Secondary markets are those in which investors may participate by trading on an exchange or over-the-counter.

Responsive to the execution of the contribution or withdrawal order, the CTF portfolio is updated to reflect the addition of assets or the reduction of assets, according to the contribution or withdrawal order placed with the CTF Trustee by the CTF investor. The CTF investor's account is similarly updated to reflect additional cash and reduced CTF units in the case of a redemption or reduced cash and additional CTF units in the case of a contribution to the CTF.

### ADDITIONAL CONSIDERATIONS

The foregoing description of the embodiments of the disclosure has been presented for the purpose of illustration; it is not intended to be exhaustive or to limit the claims to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the described purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based hereon. Accordingly, the disclosure of the embodiments is intended to be illustrative, but not limiting, of the scope of the invention, which is set forth in the following claims.

What is claimed is:

1. A method for determining an index level of a future cost of retirement index, the method comprising:
determining a target return of a periodic income from at least one security, the periodic income comprising a plurality of payments starting from a future investment date and continuing until an end date, the end date determined according to a mortality rate;
determining a yield curve based on the plurality of payments, the yield curve modeling fluctuations in the payments from the future investment date to the end date;
applying a discount function to the periodic income, the discount function based on a yield curve;
determining a net present value of the periodic income with the discount function applied thereto; and
setting the index level of the future cost of retirement index based on the determined net present value.

2. The method of claim 1, wherein the discount function comprises:
adding a U.S. Treasury Bond yield curve to a first value to produce a first sum, the first value equal to a half of the difference between a BBB-rated corporate bond yield curve and an AA-rated corporate bond yield curve; and
subtracting from the first sum a first fixed spread, the fixed spread a function of an error term.

3. The method of claim 2, wherein the discount function is further adjusted by a risk charge corresponding to an adjustment in the mortality rate.

4. The method of claim 1, wherein the discount function comprises:
adding a U.S. Treasury Bond yield curve to a first value to produce a first sum, the first value equal to a half of the difference between a BBB-rated corporate bond yield curve and an A-rated corporate bond yield curve; and
subtracting from the first sum a first fixed spread, the fixed spread a function of an error term.

5. The method of claim 4, wherein the discount function is further adjusted by a risk charge corresponding to an adjustment in the mortality rate.

6. The method of claim 1, wherein the end date corresponds to a retirement age of an investor.

7. The method of claim 1, wherein the end date corresponds to an advanced age of an investor, the advanced age greater than eighty years old.

8. The method of claim 1, further comprising:
adding a cost of living adjustment to each payment of the plurality of payments from after the investment date; and
adjusting the index level based on the cost of living adjustment.

9. The method of claim 1, further comprising:
removing a portion from each payment of the plurality of payments from after the investment date to reflect a conditional life expectancy; and
adjusting the index level based on the removal.

10. The method of claim 1, further comprising creating a future cost of retirement fund including at least one security, a share of the fund having the index value, the at least one security of the fund selected by:
identifying a duration, a key rate duration and a yield corresponding to a periodic income of a modeled annuity purchased on the end date; and
identifying a set of securities having a duration, a key rate duration, and a yield approximating that of the modeled annuity.

11. A method for providing an investment product based on a future cost of retirement index, the method comprising:
determining a target return of a periodic income from at least one security, the periodic income comprising a plurality of payments starting from a future investment date and continuing until an end date, the end date determined according to a mortality rate;
determining a yield curve based on the plurality of payments, the yield curve modeling fluctuations in the payments from the future investment date to the end date;
applying a discount function to the periodic income, the discount function based on a yield curve;
determining a net present value of the periodic income with the discount function applied thereto;
setting an index level of the future cost of retirement index based on the determined net present value;
creating a future cost of retirement fund comprising a plurality of shares, each share of the fund having a share price based on the index value, where the fund holds one or more securities selected for the fund by a process comprising:
modeling an annuity purchased on the end date having a periodic income approximately corresponding to the index level on the end date;
estimating a duration, a key rate duration, and a yield of the modeled annuity; and
selecting the securities for the fund based at least in part on the duration, the key rate duration, and the yield of the modeled annuity.

12. The method of claim 11, wherein the discount function comprises:
adding a U.S. Treasury Bond yield curve to a first value to produce a first sum, the first value equal to a half of the difference between a BBB-rated corporate bond yield curve and an AA-rated corporate bond yield curve; and
subtracting from the first sum a first fixed spread, the fixed spread a function of an error term.

13. The method of claim 11, wherein the discount function comprises:
adding a U.S. Treasury Bond yield curve to a first value to produce a first sum, the first value equal to a half of the difference between a BBB-rated corporate bond yield curve and an A-rated corporate bond yield curve; and
subtracting from the first sum a first fixed spread, the fixed spread a function of an error term.

14. The method of claim 11, further comprising:
adding a cost of living adjustment to each payment of the plurality of payments from after the investment date; and
adjusting the index level based on the cost of living adjustment.

15. The method of claim 11, further comprising:
removing a portion of each payment of the plurality of payments from after the investment date to reflect a conditional life expectancy; and
adjusting the index level based on the removal.

16. A method for providing an investment product based on a future cost of retirement index, the method comprising:
determining a target return of a periodic income from at least one security, the periodic income comprising a plurality of payments starting from a future investment date and continuing until an end date, the end date determined according to a mortality rate;
applying a discount function to the periodic income, the discount function based on a yield curve;
determining a net present value of the periodic income with the discount function applied thereto;
setting an index level of the future cost of retirement index based on the determined net present value;
creating a future cost of retirement fund comprising a plurality of shares, each share of the fund having a share price based on the index value, where the fund holds one or more securities selected for the fund by a process comprising:
modeling an annuity purchased on the end date and having a periodic income approximately corresponding to the index level;
estimating a duration times a spread of the modeled annuity; and
selecting the securities for the fund based at least in part on the duration, and the duration times the spread of the modeled annuity.

17. The method of claim 16, wherein the discount function comprises:
adding a U.S. Treasury Bond yield curve to a first value to produce a first sum, the first value equal to a half of the difference between a BBB-rated corporate bond yield curve and an AA-rated corporate bond yield curve; and
subtracting from the first sum a first fixed spread, the fixed spread a function of an error term.

18. The method of claim 16, wherein the discount function comprises:
adding a U.S. Treasury Bond yield curve to a first value to produce a first sum, the first value equal to a half of the difference between a BBB-rated corporate bond yield curve and an A-rated corporate bond yield curve; and
subtracting from the first sum a first fixed spread, the fixed spread a function of an error term.

19. The method of claim 16, further comprising:
adding a cost of living adjustment each payment of the plurality of payments from after the investment date; and
adjusting the index level based on the cost of living adjustment.

20. The method of claim 16, further comprising:
removing a portion from each payment of the plurality of payments from after the investment date to reflect a conditional life expectancy; and
adjusting the index level based on the removal.
